(19) United States
(12) Patent Application Publication
(10) Pub. No.: US 2004/0264941 A1
(43) Pub. Date: Dec. 30, 2004

(54) Recorder/reproducer

(76) Inventor: Hisato Hirasaka, Tokyo (JP)

Correspondence Address: William S Frommer, Frommer Lawrence & Haug, 745 Fifth Avenue, New York, NY, 10151, US

(21) Appl. No.: 10/494,492

(22) PCT Filed: Oct. 15, 2002
(86) PCT No.: PCT/JP02/10666

(30) Foreign Application Priority Data
Nov. 6, 2001 (JP) 2001-341076

(51) Int. Cl. H04N 7/64

(52) U.S. Cl. 386/115

(57) ABSTRACT

There is provided a recording/playback apparatus including a playback system which reproduces data by digitizing a playback signal from a magnetic tape (140) and extracting a channel clock from the digitized playback signal. In the recording/playback apparatus, a crosstalk canceller (130) is provided upstream of a PLL circuit (127) which extracts a channel clock from read RF data resulted from digitization of the playback signal from the magnetic tape (140). The crosstalk canceller (130) includes a subtraction circuit (131) supplied with the read RF data, and an adaptive filter (132) which generates a pseudo recording signal crosstalk from recording data supplied from a recording system (110) as a signal causing a crosstalk signal included in the playback signal from the magnetic tape (140) and output data from the subtraction circuit (131). The pseudo recording signal crosstalk signal generated by the adaptive filter (132) is supplied to the subtraction circuit (131).

### TECHNICAL FIELD

The present invention relates to a recording/playback apparatus with a playback system which reproduces data by digitizing a playback signal from a recording medium and extracting a channel clock from the digitized playback signal.

### BACKGROUND ART

Generally, the commercial broadcasting equipment, computer backup apparatus (tape streamer), etc. are designed to be able to make a check operation called RAW (read after write) for checking whether a signal has been correctly recorded by playing back the signal just after recorded.

Note that the above phrase “playing back the signal just after recorded” in the RAW operation means “playing back the signal just after recorded to a tape by a write head”, not “playing back the signal after rewinding the tape to which the signal has been recorded”. For example, the magnetic recording/playback apparatus of a helical scan type is designed to make a RAW operation in a drum rotation after the drum has been rotated for recording. The magnetic recording/playback apparatus of the linear scan type makes a RAW operation with a write head disposed downstream of a read head.

Note that whether signal has been correctly recorded is judged in the analog VTR (video tape recorder) by determining the magnitude of a reproduce voltage and in a digital-recording tape streamer by determining the error rate.

For example, in a tape streamer generally indicated with a reference number 700 in FIG. 24, data is recorded to, or played back from, a magnetic tape 740 by a recording system generally indicated with a reference number 710 or a playback system generally indicated with a reference number 720, respectively.

In the recording system 710, recording data, of which the data rate is 100 MHz and that is driven by a writing clock of 100 MHz generated by a crystal oscillator, is amplified by a write amplifier 711, supplied to a write head 713 via a rotary transformer 712 and thus recorded to a magnetic tape 740.

In the playback system 720, a playback RF signal by a read head 721 from the magnetic tape 740 is amplified by a read amplifier 722 and supplied to an equalization circuit 724 via a rotary transformer 723. A channel clock (reading clock) is extracted by a PLL circuit 725 from the playback signal equalized in waveform by the equalization circuit 724, and a detecting-point voltage of an output from the equalization circuit 724 is sampled by an analog-to-digital converter (ADC) 726 driven by the channel clock. The data sampled by the ADC 726 is formed by a playback signal discrimination circuit 727 such as a Viterbi decoder into binary playback data. Th channel clock extracted by the PLL circuit 725 is used as the sampled data from the ADC 726 as well as an operation clock of each of various circuits provided downstream of the PLL circuit 725. The frequency of the channel clock extracted by the PLL circuit 725 is roughly equal to the writing clock of 100 MHz, but strictly saying, it is a 100 MHz±Drum jitter since it includes a drum jitter due to an uneven drum rotation.

However, to perform th RAW function, the above helical-scan type streamer 700 should has provided therein a strong shielding structure to electromagnetically shield the recording and playback systems 710 and 720 from each other in order to inhibit a weak playback signal from mixing with a recording signal, namely, suppress a crosstalk between the playback and recording signals, operate simultaneously, since the write and read heads 713 and 721 located near each other, and the recording and playback rotary transformers 712 and 723, which transmit signals to these heads 713 and 721, respectively, operate simultaneously, as shown in FIG. 24. More specifically, the recording signal supplied from the write amplifier 711 to the write head 713 via the rotary transformer 712 has a strong amplitude as large as 10 V while the playback RF signal by the read head 721 from the magnetic tape 740 has a weak amplitude as small as 0.1 mV. That is, the ratio in voltage between the recording and playback signals is as large as the fifth power of 10. Therefore, for such an effect of shielding as much as 100 dB, there is required a space for insertion of a shielding material and the shielding structure should be strong enough for the shielding effect, which will make it difficult to attain a small design of the drum and thus of the recording/playback apparatus.

To inhibit a crosstalk from a recording signal to a playback signal, there have been proposed techniques for inhibiting such a crosstalk not by the above-mentioned shielding structure but by a signal processing. A typical one of the conventional crosstalk suppressing techniques is known from the disclosure in the Japanese Published Unexamined Patent Application Nos. 1997-245307 and 1998-177701, for example, in which a pseudo recording signal crosstalk generated by passing a recording signal through an adaptive filter is subtracted from a playback signal to cancel the crosstalk component of the recording signal mixing with the playback signal.

The technique disclosed in the Japanese Published Unexamined Patent Application No. 1998-177701 is such that as shown in FIG. 25, an input to, and an output from, the playback signal discrimination circuit 727 are compared with each other in an error detector 731 to provide an error detection signal, an adaptive filter 732 whose characteristic is controlled with the error detection signal generates a pseudo recording signal crosstalk from the recording signal, and the pseudo recording signal crosstalk is subtracted from the playback signal by a subtraction circuit provided downstream of the ADC 726 driven by a channel clock extracted by the PLL circuit 725 in the playback system 720, to thereby cancel the crosstalk component of the recording signal mixing with the playback signal.

On the other hand, the technique disclosed in the Japanese Published Unexamined Patent Application No. 1998-177701 is such that a crosstalk is canceled in a system part located downstream of the ADC 726 driven with a channel clock extracted by the PLL circuit 725. On this account, the S/N (signal-to-noise) ratio of a reproduce RF signal supplied to the PLL circuit 725 in the playback system 720 should be high enough for the PLL circuit 725 to operate normally. Since an error detection signal obtained by a comparison between an input to, and an output from, the playback signal discrimination circuit 727 is fed back to the adaptive filter 732, the S/N ratio of the reproduce RF signal supplied to the playback signal discrimination circuit 727 should be so high. That is, the crosstalk can be canceled only when the S/N ratio of the reproduce RF signal is high. If the recording signal crosstalk is too large, the crosstalk cannot normally be canceled due to a reduction of the S/N ratio of the reproduce RF signal. Namely, this technique is effective only for a playback signal having a certain degree of equality.

However, the playback RF signal by the read head from the magnetic tape 740 is increasingly smaller due to a higher density of recording. In addition, there is a tendency that the higher recording/playback frequency causes the shielding effect to be lower and the recording signal crosstalk to increase.

Therefore, further increasing of the recording density will cause the S/N ration of the RF signal to be lower, which will makes it impossible to normally cancel the crosstalk.

The technique disclosed in the Japanese Published Unexamined Patent Application No. 1998-177701 requires a sorting circuit 734 for correction of an inequality between the reading PLL clock and writing clock. The sorting circuit 734 is a complicated one, and this technique can only be implemented with an adaptive filter formed from a transversal filter having a small number (about five) taps. Therefore, the filter to generate a recording signal crosstalk cannot be designed to have many taps, and thus the crosstalk cannot be canceled with a high accuracy by this technique.

The above-mentioned inequality between the clocks will be discussed below:

The writing clock has a high-accuracy frequency (100 MHz) generated by a crystal oscillator. On the other hand, the playback signal is a little modulated in frequency due to a drum jitter and thus the reading clock phase-locked to such a playback signal by PLL has a frequency of 100 MHz±Drum jitter. That is, when the writing clock phase is taken as a reference, the phase of the reading clock will be unstable leading at a time while lagging at another time. As a result, the pseudo recording signal crosstalk ad recording signal crosstalk actually included in the playback signal are unequal in phase to each other at many times, which will often result in addition of noises. The technique disclosed in the Japanese Published Unexamined Patent Application No. 1998-177701 uses the sorting circuit to prevent such an inequality.

Next, a power transmission crosstalk will be explained:

Since the playback signal supplied from the read head 721 to the read amplifier 722 in the playback system 720 is weak, it is effective for the prevention of crosstalk to minimize the wiring distance. On this account, the read amplifier 722 is disposed on the rotating drum in many recording/playback apparatuses of the helical scan type. However, it is actually difficult to design the power supply to a circuit on the rotating drum. In many cases, a rotary transformer is used as a means for DC transmission to a body of rotation to transmit a power on an AC signal, and the AC signal is rectified and smoothed on the rotating drum to provide a constant voltage. In these cases, when the AC signal has a frequency of 100 kHz, a crosstalk of 100 kHz will take place, so that it will also be important to cancel the power transmission signal crosstalk.

### DISCLOSURE OF THE INVENTION

Accordingly, the present invention has an object to overcome the above-mentioned drawbacks of the related art by providing a recording/playback apparatus with a function of making recording and playback operations simultaneously, capable of positively reducing, by a signal processing, crosstalk components of a recording signal and power transmission signal, that will mix with a playback signal.

According to the present invention, a crosstalk is canceled with a high accuracy by having a series of recording data and a series of power transmission signal act on a playback data series sampled with a writing clock.

The above object can be attained by providing a recording/playback apparatus provided with a playback system which reproduces data by digitizing a playback signal from a recording medium and extracting a channel clock from the digitized playback signal, the apparatus including according to the present invention:

a crosstalk canceller composed of an adaptive filter which generates a pseudo crosstalk signal from a signal causing a crosstalk signal included in the playback signal from the recording medium and the playback signal having the crosstalk signal canceled therefrom, and a calculating means for generating the playback signal having the crosstalk signal canceled therefrom by subtracting the pseudo crosstalk signal from the digitized playback signal; and

a channel clock extracting means provided upstream of the crosstalk canceller to extract a channel clock from the digitized playback signal,

the crosstalk included in the digitized playback signal being canceled by the crosstalk canceller before the playback signal arrives at the channel clock extracting means.

In the above recording/playback apparatus according to the present invention, the adaptive filter may have a function of optimizing the characteristic of the adaptive filter.

Also, in the above recording/playback apparatus according to the present invention, the adaptive filter may have a function of optimizing the characteristic of the adaptive filter and storing the filter factor included in the optimized adaptive filter characteristic into a non-volatile storage means.

Also, the above recording/playback apparatus according to the present invention may be arranged such that recording data from a recording system which records data to the recording medium is supplied as a signal causing a crosstalk signal included in the playback signal from the recording medium to the adaptive filter and the playback signal from the recording medium is digitized by an analog-to-digital conversion means driven with a recording clock of the recording system and a recording signal crosstalk included in the digitized playback signal is canceled by the crosstalk canceller, in the playback system.

Also, the above recording/playback apparatus according to the present invention may be arranged such that a power transmission signal from a power transmission system is supplied as a signal causing a crosstalk included in the playback signal from the recording medium to the adaptive filter and in the playback system and a power transmission signal crosstalk is cancelled by the crosstalk canceller.

Also, the above recording/playback apparatus according to the present invention may be arranged such that a power transmission signal synchronous with a driving clock of the analog-to-digital conversion means which digitizes the playback signal from the recording medium is supplied from the power transmission system to the adaptive filter.

Also, the above recording/playback apparatus according to the present invention may further include a sampling means for sampling, with the driving clock, a power transmission signal asynchronous with the driving clock of the analog-to-digital conversion means which digitizes the playback signal from the recording medium, a power transmission signal sampled by the sampling means being supplied from the power transmission system to the adaptive filter.

Also, in the above recording/playback apparatus according to the present invention, the crosstalk canceller may include a first adaptive filter supplied with recording data from the recording system which records data to the recording medium as a signal causing a crosstalk signal included in a playback signal from the recording medium, and a second adaptive filter supplied with a power transmission signal from the power transmission system, and cancel the recording signal crosstalk and power transmission signal crosstalk in the playback system.

Also, the above recording/playback apparatus according to the present invention may include an RMIC (remote memory in cassette) signal recording/playback system which uses a tape cassette having installed therein a non-volatile having stored therein a variety of management information concerning recording to, and playback from a magnetic tape as a recording medium and a remote memory chip including an antenna, radio communication circuit, etc. and writes or reads data to and from the non-volatile memory without any contact with the tape cassette, an RMIC signal being supplied as a signal causing a crosstalk signal included in a playback signal from the recording medium from the RMIC signal recording/playback system to an adaptive filter, and an RMIC signal crosstalk being canceled by a crosstalk canceller in the playback system.

These objects and other objects, features and advantages of the present invention will become more apparent from the following detailed description of the best mode for carrying out the present invention when taken in conjunction with the accompanying drawings.

### BRIEF DESCRIPTION OF THE DRAWINGS

FIG. 1 is a block diagram of a tape streamer according to the present invention and conforming to the DDS (digital data storage) 4 Standard.

FIG. 2 is a block diagram of a variant of the tape streamer in FIG. 1, in which an equalization circuit in a playback system of the tape streamer is provided downstream of a subtraction circuit and it is formed from a transversal filter.

FIG. 3 is a block diagram of another variant of the tape streamer in FIG. 1, in which the equalization circuit in the playback system of the tape streamer is provided downstream of an ADC (analog-to-digital converter) and it is formed from a transversal filter.

FIG. 4 is a block diagram of the transversal filter as an adaptive filter.

FIG. 5 shows a flow of operations included in a sequence of optimization in the adaptive filter.

FIG. 6 shows a waveform of an analog signal resulted from digital-to-analog conversion by a DAC (digital-to-analog converter) of output data from a PLL circuit in the playback system in the tape streamer, and a signal waveform in the playback mode, showing the result of observation of an error check signal as a result of error checking made of playback data by an error correction circuit having been supplied with the playback data.

FIG. 7 shows a signal waveform in RAW mode with the crosstalk canceller in the playback system being turned off.

FIG. 8 shows a signal waveform in RAW mode with the crosstalk canceller in the playback system being turned on.

FIG. 9 is a block diagram of the substantial part of the tape streamer in which a power transmission signal crosstalk is canceled according to the present invention.

FIG. 10 is also a block diagram of the substantial part of the tape streamer in which the reference clock of a power transmission signal generation circuit is equal to an ADC clock.

FIG. 11 is a block diagram of the substantial part of the tape streamer in which output data from the power transmission signal generation circuit which operates independently of the ADC clock is re-sampled with the ADC clock to provide a power transmission signal synchronous with the ADC clock.

FIG. 12 is a detailed block diagram of a power transmission system which provides a power transmission signal asynchronous with the ADC clock.

FIG. 13 shows a signal waveform when the secondary voltage is elevated in the power transmission system.

FIG. 14 shows a signal waveform when the secondary voltage is lowered in the power transmission system.

FIG. 15 is a block diagram of the substantial part of the tape streamer in which a recording signal crosstalk and power transmission signal crosstalk are canceled in the playback system according to the present invention.

FIG. 16 is a perspective view of a helical-scan rotating drum in a tape streamer including a four-channel recording system.

FIG. 17 is a plan view schematically illustrating the head location and tape winding on the helical-scan rotating drum.

FIG. 18 is a block diagram of the substantial part of the tape streamer including the four-channel recording system according to the present invention.

FIG. 19 is also a block diagram of a crosstalk canceller included in the tape streamer.

FIG. 20 is a timing chart showing operations of the tape streamer.

FIG. 21 is a block diagram of the substantial part of the tape streamer in which an RMIC signal crosstalk is canceled in the playback system according to the present invention.

FIG. 22 is also a block diagram of the substantial part of the tape streamer in which the reference clock of an RMIC signal generation circuit is equal to the ADC clock.

FIG. 23 is a block diagram of the substantial part of the tape streamer in which output data from the RMIC signal generation circuit which operates independently of the ADC clock is re-sampled with the ADC clock to provide an RMIC signal synchronous with the ADC clock.

FIG. 24 is a block diagram of a conventional tape streamer.

FIG. 25 is also a block diagram of a tape streamer including a conventional crosstalk canceller.

### BEST MODE FOR CARRYING OUT THE INVENTION

The present invention will be described in detail concerning the embodiments thereof with reference to the accompanying drawings.

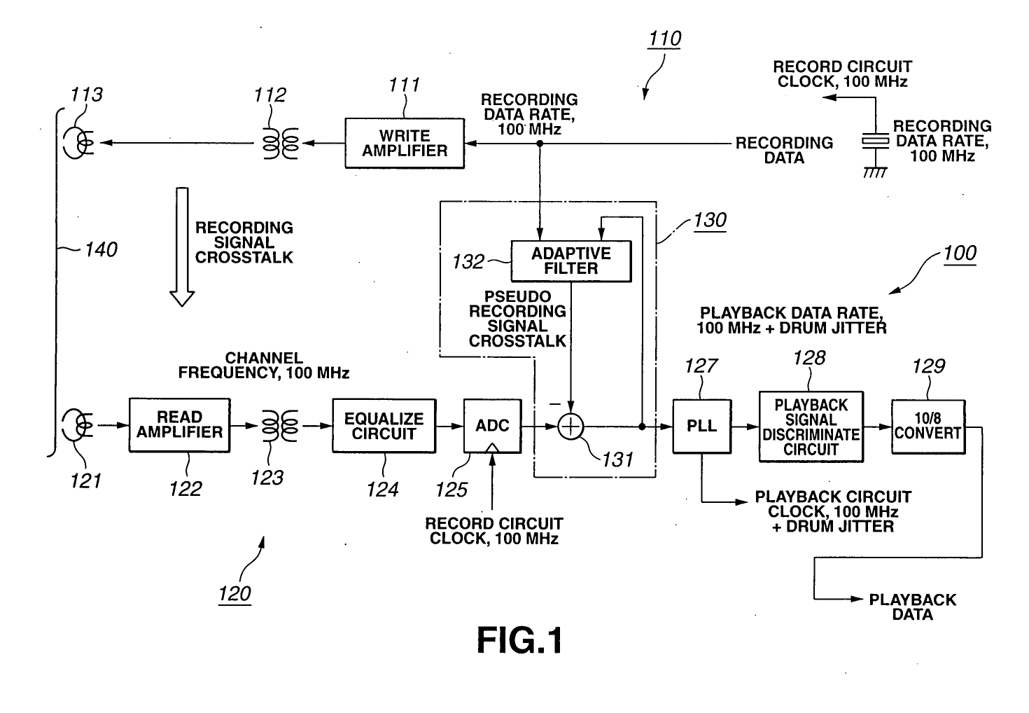

Referring now to FIG. 1, there is schematically illustrated in the form of a block diagram a tape streamer as a first embodiment of the present invention and conforming to the DDS (digital data storage) 4 Standard. The tape streamer is generally indicated with a reference number 100.

In a recording system 110 included in the tape streamer 100 shown in FIG. 1, recording data driven by a writing clock (100 MHz) from an crystal oscillator and whose data rate is 100 MHz is amplified by a write amplifier 111 to about 10 V, and supplied to a write head 113 via a rotary transformer 112. Thus, the recording data is recorded to a recording track on a magnetic tape 140.

In a playback system 120 also included in the tape streamer 100, the recording track on the magnetic tape 140 having the recording data recorded thereto by the write head 113 is scanned by a read head 121 to provide a reproduce RF signal. Since the output voltage of the read head 121 is less than 0.1 mV, the reproduce RF signal from the read head 121 is amplified by a read amplifier 122 disposed near the read head 121 to prevent any noise from mixing in the reproduce RF signal, and supplied to an equalization circuit 124 via a rotary transformer 123.

The equalization circuit 124 adjusts the gain and phase frequency response for the magnetic recording channel transfer characteristic to be as desired. It should be noted that although PR1, PR4, etc. are included in the magnetic recording channel transfer characteristics, they will not be described in detail because they have not direct relation with the present invention. The reproduce RF signal equalized in waveform by the equalization circuit 124 is digitized by an analog-to-digital converter (ADC) 125 driven with a writing clock (100 MHz) for the recording system 110.

The playback system 120 in the tape streamer 100 includes a crosstalk canceller 130 which is supplied with the read RF data digitized by the ADC 125. The crosstalk canceller 130 includes a subtraction circuit 131 which is supplied with the read RF data and an adaptive filter 132 which generates a crosstalk signal of a pseudo recording signal from recording data supplied from the recording system 110 and a subtraction output from the subtraction circuit 131. The pseudo recording signal crosstalk signal generated by the adaptive filter 132 will be supplied to the subtraction circuit 131.

The subtraction circuit 131 cancels the recording signal crosstalk by subtracting the pseudo recording signal crosstalk signal generated by the adaptive filter 132 from the read RF data digitized by the ADC 125.

The adaptive filter 132 automatically adjusts the transfer function, to minimize the recording signal crosstalk component included in the subtraction output data from the subtraction circuit 131, by generating a pseudo recording signal crosstalk signal from recording data supplied from the recording system 110 and subtraction output from the subtraction circuit, that is, read RF data from which the recording signal crosstalk has bee canceled, and supplying the generated pseudo recording signal crosstalk signal to the subtraction circuit 131.

The subtraction output data from the subtraction circuit 131, that is, read RF data from which the recording signal crosstalk has been canceled, is supplied to a playback signal discrimination circuit 128 via a PLL circuit 127.

The PLL circuit 127 extracts a channel clock (reading clock) from the read RF data having the recording signal crosstalk canceled therefrom.

The playback signal discrimination circuit 128 binarizes the read RF data and outputs it as playback data via a 10/8 conversion circuit 129.

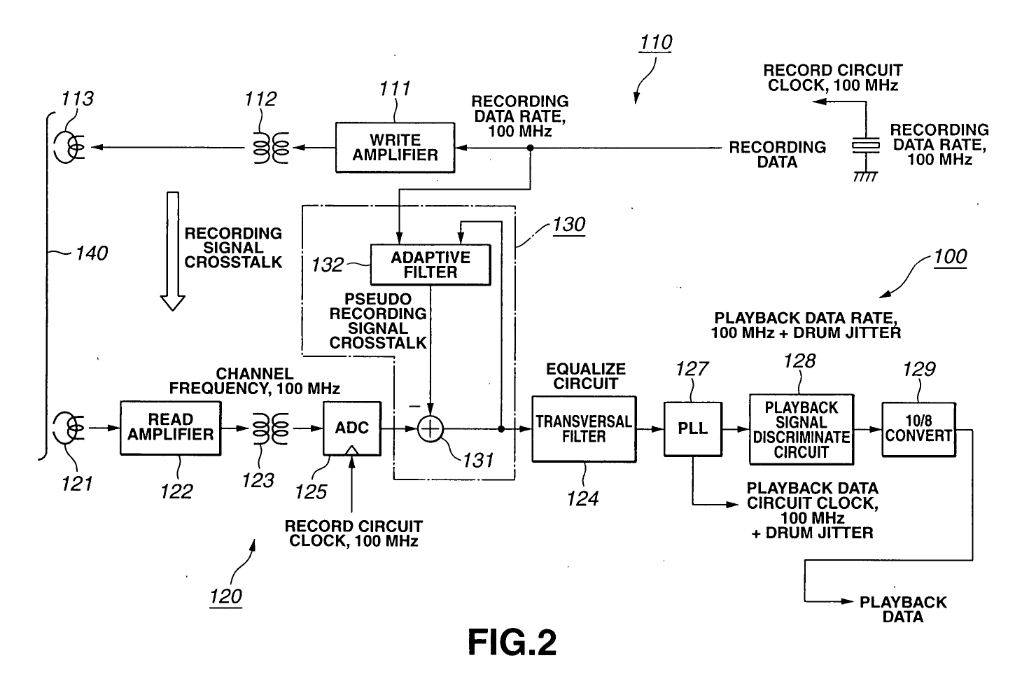

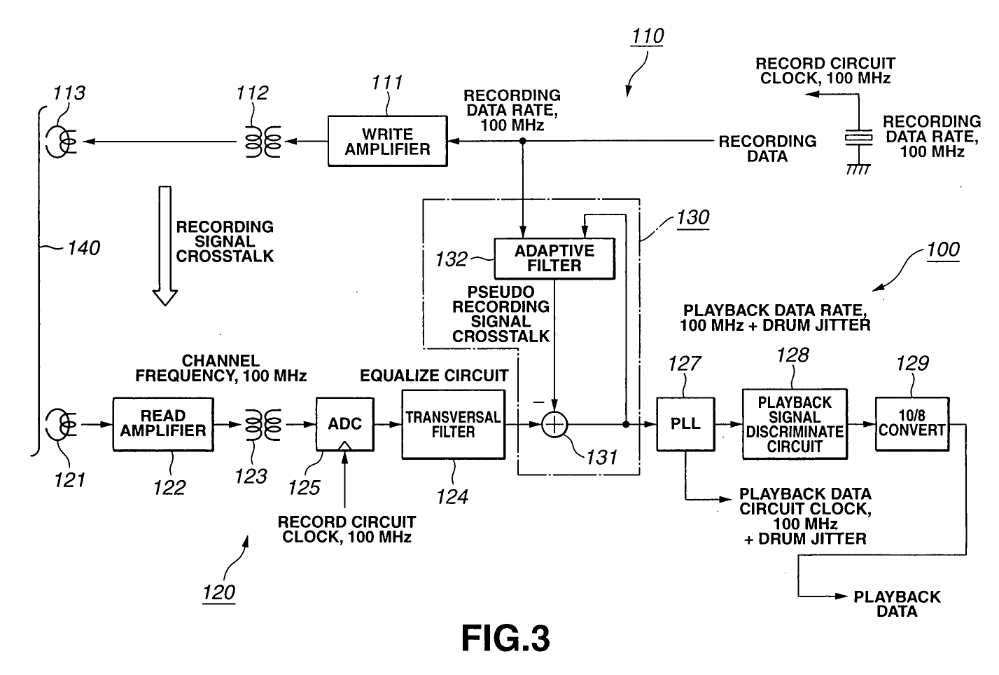

Note that as shown in FIGS. 2 and 3, the equalization circuit 124 in the playback system 120 of the tape streamer 100 may be formed from a transversal filter and disposed downstream of the crosstalk canceller 130 and ADC 125.

Next, the adaptive filter 132 which generates the pseudo recording signal crosstalk signal will be described concerning its construction and theory of operation.

Note here that the time in the sampling data series is taken as an integer i and represented by a subscript of a variable. On the assumption that the output from the subtraction circuit 131 in the crosstalk canceller 130 provided in the playback system 120 of the tape streamer 100 is vᵢ, it is given by the following equation (1):

vᵢ=sᵢ+xᵢ+nᵢ−yᵢ (1)

where s: Signal voltage

x: Recording signal crosstalk

n: Noise from a magnetic tape, magnetic head and amplifier

y: Pseudo recording signal crosstalk

When the signal voltage sᵢ and noise nᵢ are replaced by a noise N, the equation (1) is given by the following equation (2):

Nᵢ=sᵢ+nᵢ

vᵢ=xᵢ+Nᵢ−yᵢ (2)

When both the right and left sides of the equation (2) are squared, the following equation (3) results:

vᵢ²=(xᵢ−yᵢ)²+2(xᵢ−yᵢ)Nᵢ+Nᵢ² (3)

An optimum approximation of the pseudo recording signal crosstalk yᵢ to the recording signal crosstalk xᵢ means that the mean value of the time i in the first term at the right side of the equation (3) is minimized. Since the mean value of noise is zero, the right-side second term in the equation (3) is zero when averaged. The right-side third term is independent of the pseudo recording signal crosstalk yᵢ. Therefore, minimization of the time mean value in the equation (3) will result in an optimum approximation of the pseudo recording signal crosstalk yᵢ to the recording signal crosstalk xᵢ.

In case the adaptive filter 132 is formed from a transversal filter, the pseudo recording signal crosstalk yᵢ at the time i is given by the following equation (4):

$${y}_{i} = {\sum }_{j} {C}_{j} {r}_{i - j} \qquad ( 4 )$$

where Cⱼ: Tap coefficient

j: Tap number

r: Recording data

At this time, the tap coefficient Cⱼ may be updated according to the following equation (5) for the time mean value in the equation (3) to be minimized:

$$Cj -> {C}_{j} - α \frac{\partial {v}_{i}^{2}}{\partial {C}_{j}} \qquad ( 5 )$$

where α: Constant for determining a converging rate.

The above equation (5) will be given as the following equation (6) when the above equations (2) and (4) are placed in the equation (5):

Cⱼ→Cⱼ+2αrᵢ₋ⱼvᵢ (6)

Actually, the following equation (7) will be adopted when the number of delay clocks of the ADC 125 is taken as M:

Cⱼ→Cⱼ+2αr_{i-j-M}v_{i-M} (7)

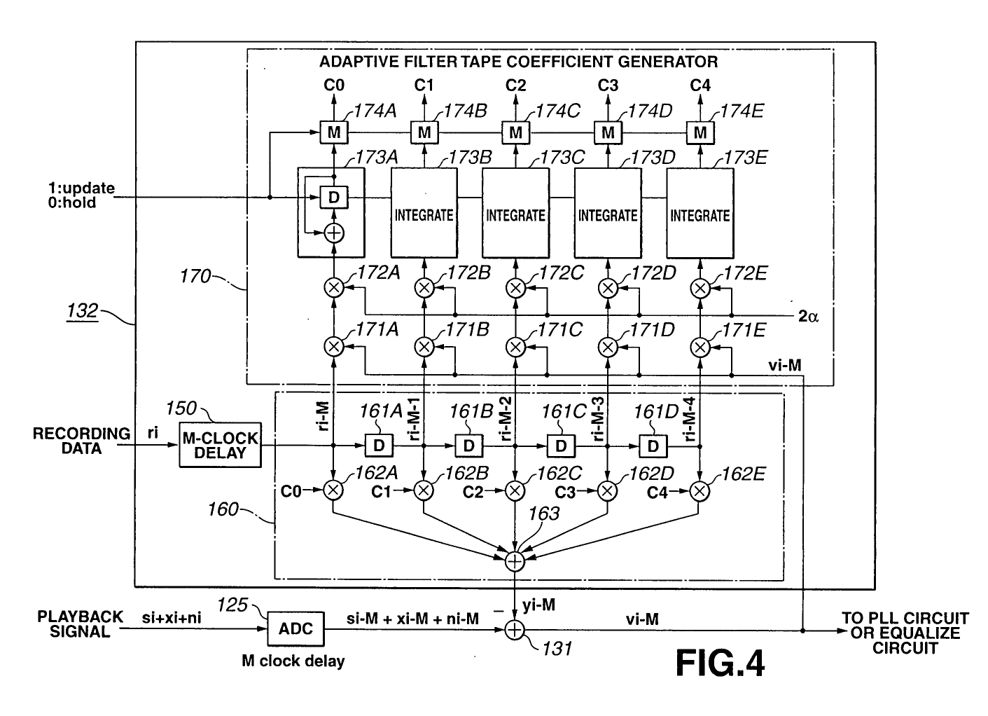

FIG. 4 is a block diagram of a 5-tap transversal filter (j=0, 1, 2, 3, 4), which is a rewrite of the above equation (7).

As shown in FIG. 4, the 5-tap transversal filter (j=0, 1, 2, 3, 4) is composed of a filter block 160 which is supplied with recording data rᵢ via an M-clock delay circuit 150, and an adaptive filter factor generation block 170.

The M-clock delay circuit 150 provides a delay corresponding to the number of delay clocks M of the ADC 125. Namely, the M-clock delay circuit 150 applies the number of delay clocks M of the ADC 125 to the recording data rᵢ supplied from the recording system 110.

The filter block 160 includes a D-type flip-flop 161A and coefficient multiplier 162A, which are supplied with recording data r_{i-M} having been delayed by the M-clock delay circuit 150, a D-type flip-flop 161B and coefficient multiplier 162B, which are supplied with recording data r_{i-M-1} having been delayed one more clock by the flip-flop 1621 A, a D-type flip-flop 161C and coefficient multiplier 162C, which are supplied with recording data r_{i-M-2} having been delayed one more clock by the D-type flip-flop 161B, a D-type flip-flop 161D and coefficient multiplier 162D, which are supplied with recording data r_{i-M-3} having been delayed one more clock by the D-type flip-flop 161C, a coefficient multiplier 162E which is supplied with recording data r_{i-M-4} having been delayed one more clock by the D-type flip-flop 161D, and an adder 163 which adds together multiplication outputs from the coefficient multipliers 162A to 162E, respectively. The coefficient multipliers 162A to 162E multiply the recording data r_{i-M}, r_{i-M-1}, r_{i-M-2}, r_{i-M-3} and r_{i-M-4} by an adaptive filter coefficient Cⱼ (j=0, 1, 2, 3, 4) generated by an adaptive filter tap coefficient generator 170.

Further, the adaptive filter tap coefficient generator 170 includes multipliers 171A to 171E which are supplied with the recording data r_{i-M}, r_{i-M-1}, r_{i-M-2}, r_{i-M-3} and r_{i-M-4}, multipliers 172A to 172E which are supplied with multiplication outputs from the multipliers 171A to 171E, respectively, integration circuits 173A to 173E which are supplied with multiplication outputs from the multipliers 172A to 172E, respectively, and memories 174A to 174E which store integration outputs from the integration circuits 173A to 173E, respectively. The multipliers 171A to 171E has supplied thereto output values v_{i-M} from the subtraction circuit 131 and multiplies each of the recording data r_{i-M}, r_{i-M-1}, r_{i-M-2}, r_{i-M-3} and r_{i-M-4} by the output value vᵢ from the subtraction circuit 131. The multipliers 172A to 172E has supplied thereto a constant 2α for determining the converging rate and multiplies each of the multiplication outputs from the multipliers 171A to 171E by the constant 2α. The memories 174A to 174E store the integration output from each of the integration circuits 173A to 173E which integrate the multiplication outputs from the multipliers 172A to 172E, and supply the result of integration as the adaptive filter coefficient Cⱼ (j=0, 1, 2, 3, 4) to the coefficient multipliers 162A to 162E of the filter block 160. Each of the memories 174A to 174E is formed from a non-volatile memory.

In the adaptive filter 132 using the 5-tap transversal filter (j=0, 1, 2, 3, 4) constructed as above, the filter block 160 generates a pseudo recording signal crosstalk y_{i-M} by adding, by the adder 163, the multiplication outputs from the coefficient multipliers 162A to 162E which multiply the recording data r_{i-M}, r_{i-M-1}, r_{i-M-2}, r_{i-M-3} and r_{i-M-4} by the adaptive filter tap coefficient Cⱼ (j=0, 1, 2, 3, 4) to make an adaptive filtering of the recording data r_{i-M} generated by the adaptive filter tap coefficient generator 170 with the adaptive filter tap coefficient Cⱼ (j=0, 1, 2, 3, 4).

The adaptive filter 132 formed from the transversal filter constructed as shown in FIG. 4 needs not any sorting circuit (recording signal sorting means) used in the technique disclosed in the Japanese Published Unexamined Patent Application No. 1998-177701 since the crosstalk canceller makes all operations with the ADC clock.

The tape steamer 100 will not incur any malfunction of the PLL circuit 127 and playback signal discrimination circuit 128 because the crosstalk is canceled upstream of the PLL circuit 127. That is, the tape streamer 100 can operate even with a low S/N ratio. Since all the circuits work with the ADC clock, no recording signal sorting means will be required, which will lead to a simpler system construction. A high-precision crosstalk cancel by a multi-tap transversal filter such as a 10-tap transversal filter can be achieved according to the present invention, but not by the technique disclosed in the Japanese Published Unexamined Patent Application No. 1998-177701.

Generally, such as crosstalk canceling means will contribute to a higher apparatus reliability by reducing the error rate of the RAW operation and permitting a higher accuracy of detecting a head contamination and tape defect, for which the RAW operation is intended.

Note that the adaptive filter 132 formed from the transversal filter shown in FIG. 4 may be designed to operate in “update” and “hold” modes.

In this case, a recording signal is outputted without appearance of any playback signals, and the adaptive filter 132 is set to the update mode and the apparatus waits until it is optimized. Thereafter, the adaptive filter 132 is set to the hold mode and continuously used in the hold mode. Since the optimum adaptive filter characteristic is maintained until the power is shut off, the adaptive filter 132 is set to the update mode only once in principle. However, the adaptive filter 132 may be arranged to operate in the update mode at every 24 hours.

The above system is advantageous in that the adaptive filter 132 can function without being influenced by playback signals. For allowing no playback signals to appear, there are available various methods such as ejection of the a cassette, unloading of a tape, stopping of a drum from rotating (in a helical-scan type apparatus), stopping of the tape from running (in a linear-recording type apparatus), putting into run of a tape without any magnetic substance (cleaning tape), or the like.

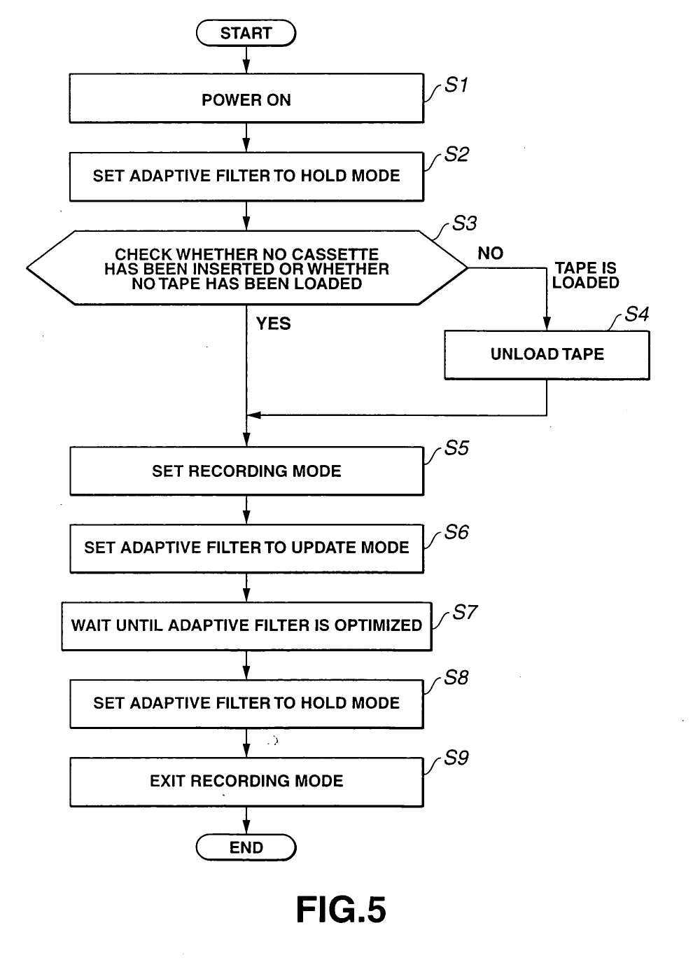

An example of the sequence of optimizing operations made in the adaptive filter 132 will be described herebelow with reference the flow chart shown in FIG. 5. The example in FIG. 5 is such that a tape is unloaded for appearance of no playback signals.

In step S1, the power is turned on. Then in step S2, the adaptive filter 132 is set to the hold mode, and it is judged in step S3 whether no cassette has been inserted or whether no tape is loaded.

When the result of the judgment in step S3 is negative (NO), namely, if a tape is loaded, the tape is unloaded in step S4 and the apparatus is set to the recording mode instep S5. When the result of the judgment in step S3 is affirmative (YES), that is, if no playback signals will appear, the apparatus is set to the recording mode in step S5.

In step S6, the adaptive filter is set to the update mode. Next in step S7, the apparatus waits until the adaptive filter 132 is optimized. Then, the adaptive filter 132 is set to the hold mode in step S8. apparatus exits the recording mode in step S9, and the adaptive filter 132 is continuously used in the hold mode. Since the optimum adaptive filter characteristic is maintained until the power is shut off, the adaptive filter 132 is set to the update mode only once in principle. However, the adaptive filter 132 may be arranged to operate in the update mode at every 24 hours.

Each of the memories 174A to 174E in the adaptive filter 132 stores a new tap coefficient when in the update mode. In the hold mode, however, each of the memories 174A to 174E continuously outputs a last tap coefficient. Since each of these memories 174A to 174E is a non-volatile one, the last tap coefficient will remain even if the power is shut off. Since the tape coefficient stored in the memories 174A to 174E is supplied to the adaptive filter 132 when the power is turned on again and subsequently, the optimization having been explained above with respect to FIG. 5 will be unnecessary.

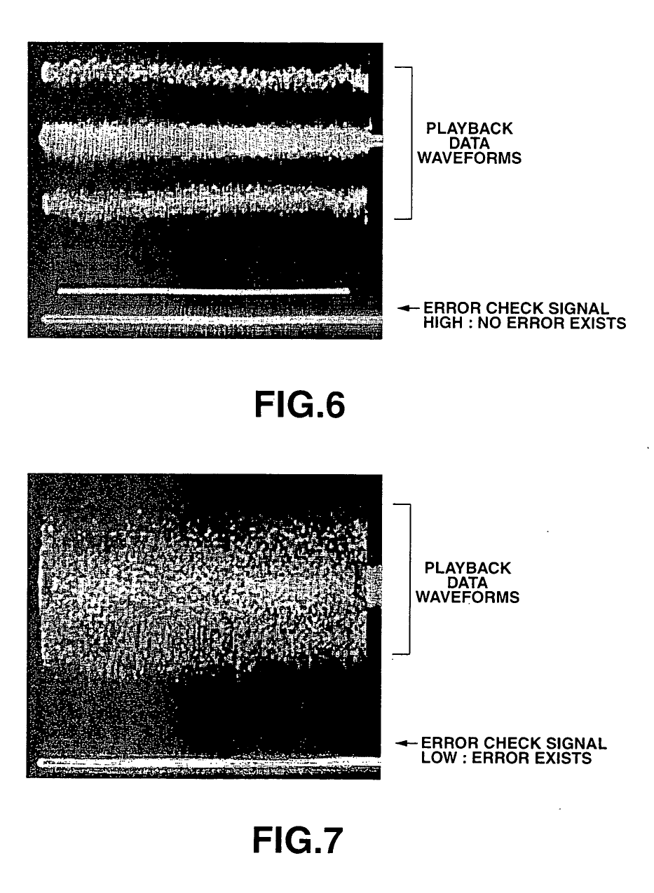

A waveform of an analog signal resulted from digital-to-analog conversion by the DAC (digital-to-analog converter) of output data from the PLL circuit 127 in the tape streamer 100 constructed as shown in FIG. 2 and a signal waveform in the playback mode, showing the result of observation of an error check signal as a result of error checking made of playback data by an error correction circuit having been supplied with the playback data are shown in FIGS. 6 to 8.

FIG. 6 shows a waveform when the apparatus is in the playback mode. Since the DDS (digital data storage) 4 Standard adopts the PR1 channel, playback data waveforms of three different values are distributed. When the apparatus is in the playback mode, no recording signal crosstalk exists, normal playback data can be provided and the error check signal takes a high level which indicates that there is no error at all the tape intervals.

FIG. 7 shows a signal waveform in the RAW mode with the crosstalk canceller 130 being turned off. In the RAW mode, the crosstalk canceller 130 is in the off state and so the PLL circuit 127 does not operate normally due to a recording signal crosstalk, the error check signal takes a low level which indicates that there exist errors at all the tape intervals, and no data reading is possible because of the errors caused by the recording signal crosstalk.

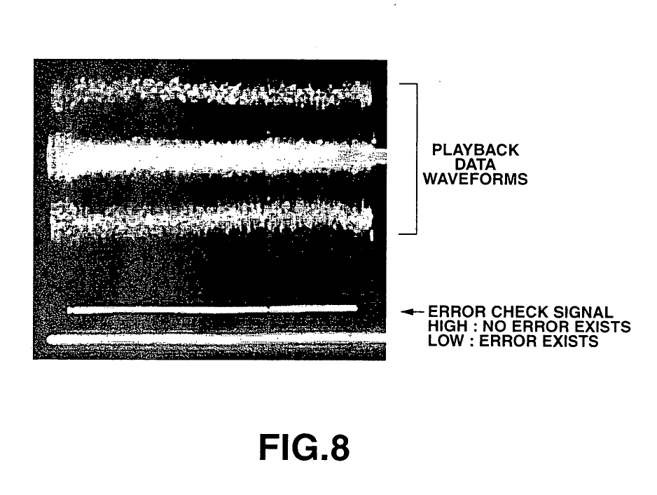

FIG. 8 shows a signal waveform in the RAW mode with the crosstalk canceller 130 being turned on. In the RAW mode, the crosstalk canceller 130 is in the on state and the recording signal crosstalk is cancelled, so the PLL circuit 127 operates normally and playback data waveforms of three different values are distributed. Normal playback data can be provided and the error check signal takes a high level which indicates that there is no error at all the tape intervals.

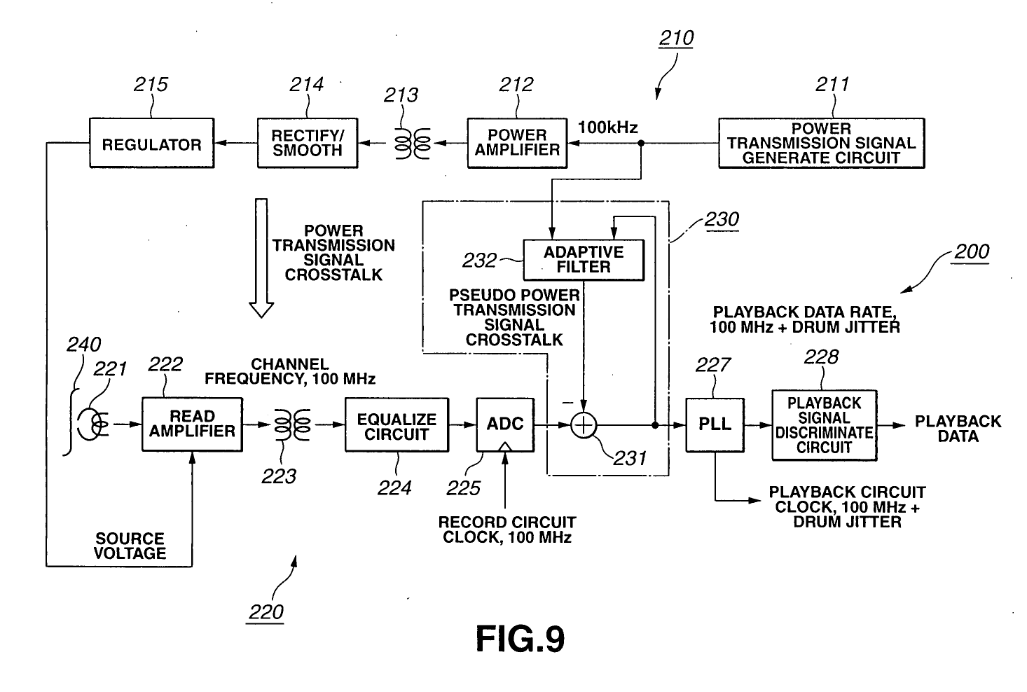

Next, a second embodiment of the tape streamer according to the present invention will be described with reference to FIG. 9. This tape streamer, generally indicated with a reference number 200, cancels a power transmission signal crosstalk according to the present invention.

In a power transmission system, generally indicated with a reference number 210, of the tape streamer 200, a power transmission signal whose recording data rate is 100 kHz, generated by a power transmission signal generation circuit 211 is amplified by a power amplifier 212 and transmitted to a rectification/smoothing circuit 214 at the rotating-unit side via a rotary transformer 213. The power transmission signal transmitted via the rotary transformer 213 is rectified and smoothed by the rectification/smoothing circuit 214 and further stabilized by a regulator 215 to provide a DC power which will drive a read amplifier 222 disposed near a read head 221 of a playback system 220.

In the playback system 220, a reproduce RF signal provided by scanning a recording track on a magnetic tape 240 by the read head 221 is amplified again by the read amplifier 222, and supplied to an equalization circuit 224 via a rotary transformer 223.

The equalization circuit 224 adjusts the gain and phase frequency response for the magnetic recording channel transfer characteristic to be as desired. It should be noted that although PR1, PR4, etc. are included in the magnetic recording channel transfer characteristics, they will not be described in detail because they have not direct relation with the present invention. The reproduce RF signal equalized in waveform by the equalization circuit 224 is digitized by an analog-to-digital converter (ADC) 225.

The playback system 220 in the tape streamer 200 includes a crosstalk canceller 230 which is supplied with the read RF data digitized by the ADC 225. The crosstalk canceller 230 includes a subtraction circuit 231 which is supplied with the read RF data and an adaptive filter 232 which generates a crosstalk signal of a pseudo power transmission signal from a power transmission signal supplied from the power transmission system 210 and a subtraction output from the subtraction circuit 231. The pseudo power transmission signal crosstalk signal generated by the adaptive filter 232 will be supplied to the subtraction circuit 231.

The subtraction circuit 231 cancels the power transmission signal crosstalk by subtracting the pseudo power transmission signal crosstalk signal generated by the adaptive filter 232 from the read RF data digitized by the ADC 225.

The adaptive filter 232 automatically adjusts the transfer function, to minimize the power transmission signal crosstalk component included in the subtraction output data from the subtraction circuit 231, by generating a pseudo power transmission signal crosstalk signal from the power transmission signal supplied from the power transmission system 210 and subtraction output data from the subtraction circuit 231, namely, read RF data having the power transmission signal crosstalk canceled therefrom, and supplying the generated pseudo power transmission signal crosstalk signal to the subtraction circuit 231.

The subtraction output data from the subtraction circuit 231, that is, read RF data from which the power transmission signal crosstalk has been canceled, is supplied to a playback signal discrimination circuit 228 via a PLL circuit 227.

The PLL circuit 227 extracts a channel clock (reading clock) from the read RF data having the power transmission signal crosstalk canceled therefrom.

The playback signal discrimination circuit 228 binarizes and outputs the read RF data.

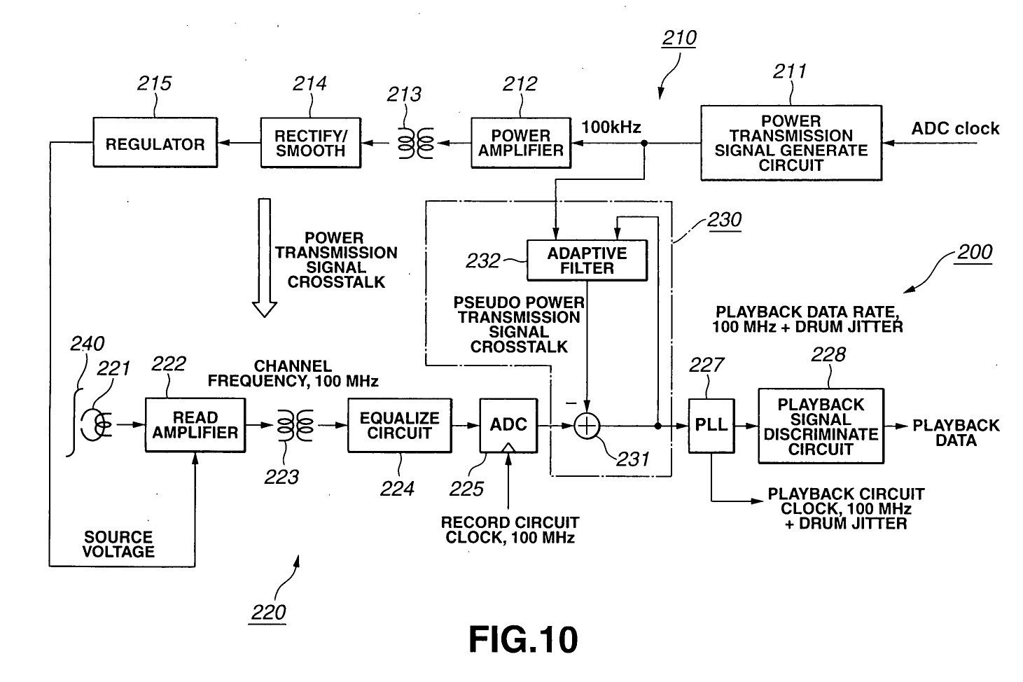

Note here that since the crosstalk cannot be canceled correctly unless the power transmission signal is not synchronous with the ADC clock, the reference clock of the power transmission signal generation circuit 211 is made equal to the ADC clock as shown in FIG. 10. With this operation, the power transmission signal can be made synchronous with the ADC clock.

More specifically, when the ADC clock is 100 MHz and the power transmission signal is 100 kHz, the power transmission signal generation circuit 211 may be a circuit which divides a frequency by 1000 (namely, a 1/1000 frequency-division circuit).

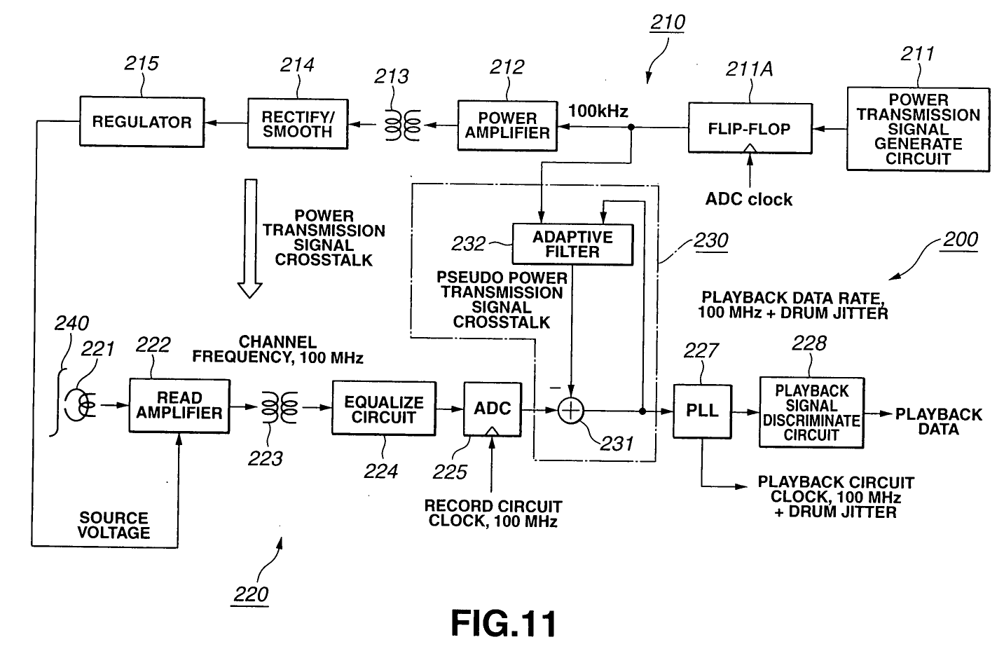

In case the power transmission signal generation circuit 211 operates independently of the ADC clock, a flip-flop 211 A which operates with the ADC clock may be provided at the output of the power transmission signal generation circuit 211 to generate a power transmission signal synchronous with the ADC clock by re-sampling the power transmission signal with the ADC clock, as shown in FIG. 11. It should be noted that the re-sampling will cause the power transmission signal to incur a duty ratio interference which however is negligibly small, causing no problem, because the ADC clock frequency ranges from several tens to several hundreds MHz, which is three orders of magnitude higher than the power transmission frequency which ranges from several tens to several hundreds kHz.

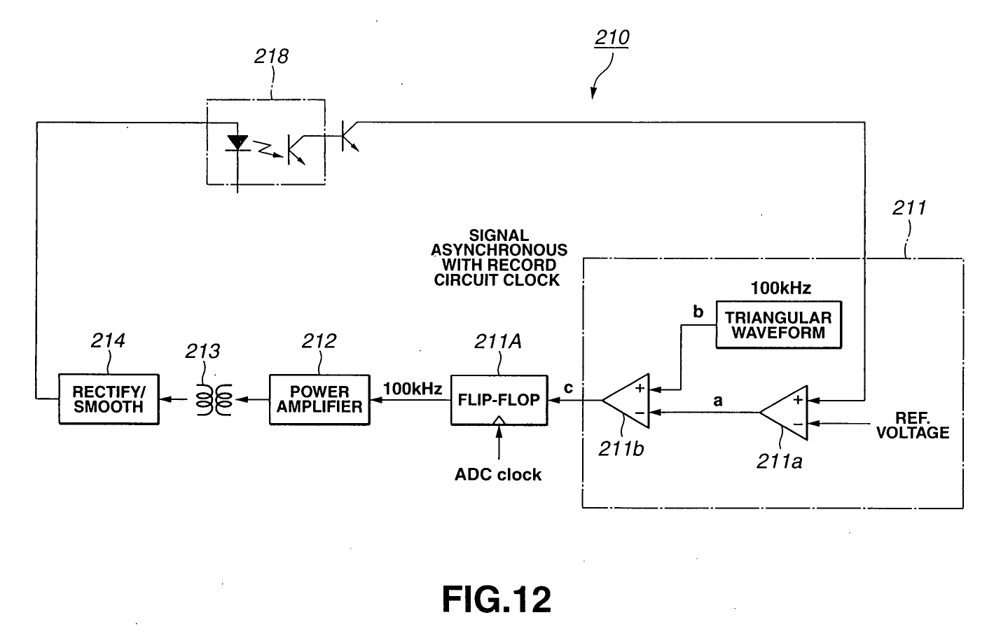

The construction of the tape streamer 200 shown in FIG. 11 is advantageously effective when a power circuit in which a voltage at the secondary side of a rotary transformer is regulated by a duty ratio control is adopted as the power transmission signal generation circuit 211. In this power transmission signal generation circuit 211, since the frequency and duty ratio are spontaneously corrected correspondingly to whether the secondary voltage is high or low, the power transmission signal will be asynchronous with the ADC clock. The power transmission system intended for this case is illustrated in FIG. 12.

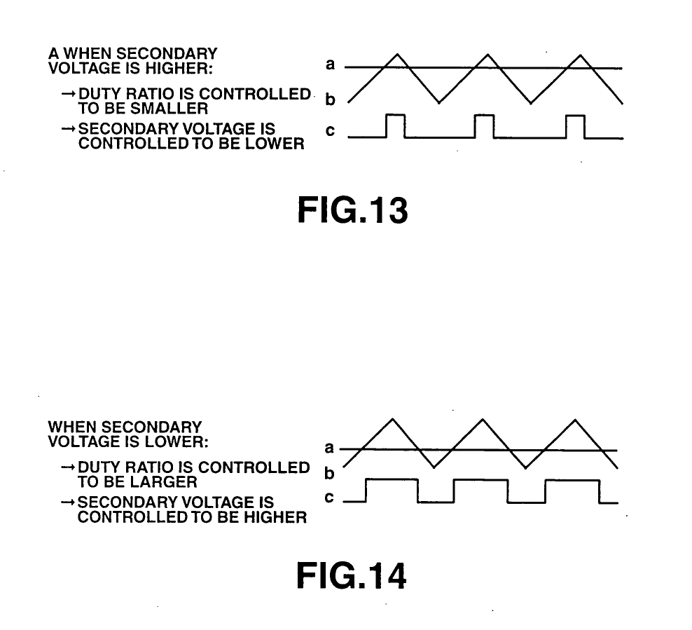

In the power transmission system 210 shown in FIG. 12, the magnitude of the secondary voltage is transmitted by a rotary photocoupler 218 to the primary side of the rotary transformer and compared with a reference voltage by a first comparator 211a in the power transmission signal generation circuit 211, and a comparison output a from the first comparator 211a is compared with a triangular wave signal b by a second comparator 211b to correct the duty ratio. When the secondary voltage is higher, the comparison output a from the first comparator 211a is elevated while the duty ratio of a comparison output c from the second comparator 211b becomes smaller, whereby the secondary voltage is adjusted to be lower, as shown in FIG. 13. On the other hand, when the secondary voltage is lower, the comparison output a from the first comparator 211a is lowered while the duty ratio of a comparison output c from the second comparator 211b becomes larger, whereby the secondary voltage is adjusted to be higher, as shown in FIG. 14.

Note here that in case the tape streamer 200 includes N recording systems and M power transmission systems, the recording signal crosstalk and power transmission signal crosstalk can be cancelled in the playback system by providing a number (N+M) of noise cancellers in the playback system.

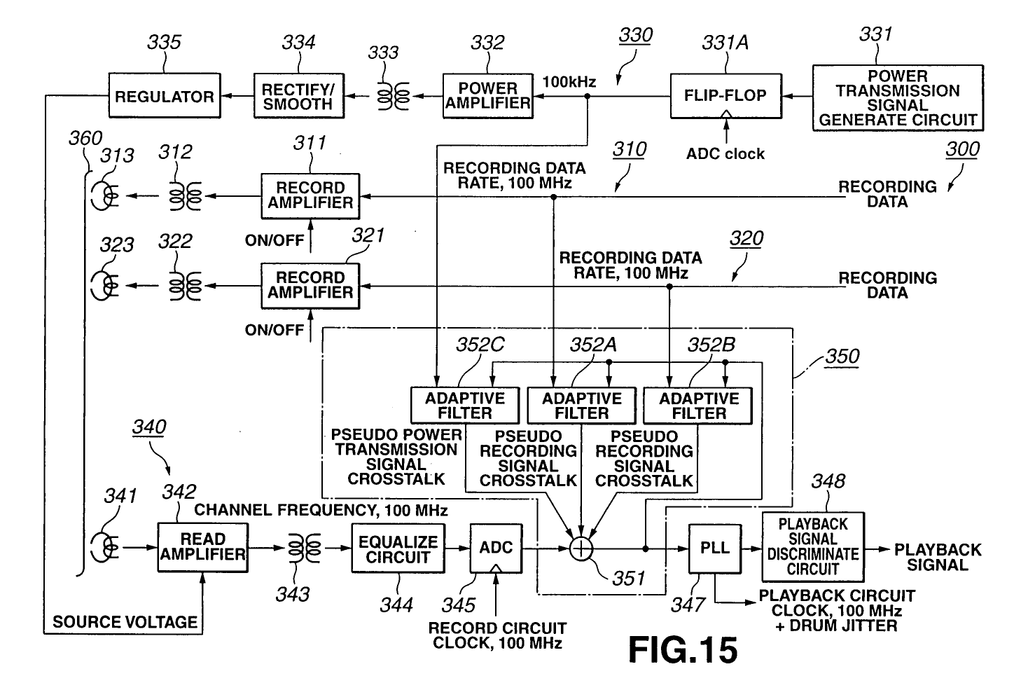

The present invention will further be described concerning a third embodiment thereof with reference to FIG. 15 which is a block diagram of the substantial part of the tape streamer, generally indicated with a reference number 300, in which the recording signal crosstalk and power transmission signal crosstalk are canceled in a playback system.

The tape streamer 300 includes first and second recording systems 310 and 320, a power transmission system 330 and a playback system 340. Recording signal crosstalk from each of the first and second recording systems 310 and 320 and power transmission signal crosstalk from the power transmission system 330 can be canceled in the playback system 340 as will be described below.

In the first recording system 310 of the tape streamer 300, recording data whose rate is 100 MHz is amplified by a write amplifier 311 and supplied to a write head 313 via a rotary transformer 312, whereby it is recorded to a recording track on a magnetic tape 360. In the second recording system 320, recording data whose rate is 100 MHz is amplifier by a write amplifier 321 and supplied to a write head 323 via a rotary transformer 322, whereby it is recorded to a recording track on the magnetic tape 360. The write amplifiers 311 and 321 in the first and second recording systems 310 and 320, respectively, are controlled to be activated and deactivated independently of each other.

In the power transmission system 330 of the tape streamer 300, a power transmission signal generated by a power transmission signal generation circuit 311 is re-sampled by a flip-flop 331A which operates with an ADC clock of 100 MHz to provide a power transmission signal synchronous with the ADC clock and whose rate is 100 MHz. The power transmission signal is amplified by a power amplifier 332 and transmitted to a rectification/smoothing circuit 334 at the rotating-unit side via a rotary transformer 333. The power transmission signal transmitted via the rotary transformer 213 is rectified and smoothed by the rectification/smoothing circuit 334 and further stabilized by a regulator 335 to provide a DC power which will drive a read amplifier 342 disposed near a read head 341 of a playback system 340.

In the playback system 340, a reproduce RF signal provided by scanning a recording track on a magnetic tape 360 by the read head 341 is amplified by the read amplifier 342, and supplied to an equalization circuit 344 via a rotary transformer 343.

The equalization circuit 344 adjusts the gain and phase frequency response for the magnetic recording channel transfer characteristic to be as desired. It should be noted that although PR1, PR4, etc. are included in the magnetic recording channel transfer characteristics, they will not be described in detail because they have no direct relation with the present invention. The reproduce RF signal equalized in waveform by the equalization circuit 344 is digitized by an analog-to-digital converter (ADC) 345.

The playback system 340 in the tape streamer 300 includes a crosstalk canceller 350 which is supplied with the read RF data digitized by the ADC 345. The crosstalk canceller 350 includes a subtraction circuit 351, a first adaptive filter 352A which generates a first pseudo recording signal crosstalk signal from the recording data supplied from the first recording system 310 and subtraction output data from the subtraction circuit 351, a second adaptive filter 352B which generates a second pseudo recording signal crosstalk signal from the recording data supplied from the second recording system 320 and subtraction output data from the subtraction circuit 351, and a third adaptive filter 352C which generates a pseudo power transmission signal crosstalk signal from the power transmission signal supplied from the power transmission system 330 and subtraction output data from the subtraction circuit 351. The first and second pseudo recording signal crosstalk signals and pseudo power transmission signal crosstalk signal, generated by the first to third adaptive filters 352A to 352C, respectively, are supplied to the subtraction circuits 351.

The subtraction circuit 351 cancels the recording signal crosstalk from the first recording system 310, recording signal crosstalk from the second recording system 320 and the power transmission signal crosstalk from the power transmission system 330 by subtracting, from the read RF data digitized by the ADC 345, the first and second pseudo recording signal crosstalk signals and pseudo power transmission signal crosstalk signal, generated by the first to third adaptive filters 352A to 352C, respectively.

The first adaptive filter 352A automatically adjusts the transfer function, to minimize the recording signal crosstalk component supplied from the first recording system 310 and included in the subtraction output data from the subtraction circuit 351, by generating the first pseudo recording signal crosstalk signal from the recording data supplied from the first recording system 310 and the subtraction output data from the subtraction circuit 351, that is, read RF data from which the recording signal crosstalk from the first recording system 310, recording signal crosstalk from the second recording system 320 and power transmission signal crosstalk from the power transmission system 330 have been canceled, and supplying the first pseudo recording signal crosstalk signal thus generated to the subtraction circuit 351.

The second adaptive filter 352B automatically adjusts the transfer function, to minimize the recording signal crosstalk component supplied from the second recording system 320 and included in the subtraction output data from the subtraction circuit 351, by generating the second pseudo recording signal crosstalk signal from the recording data supplied from the second recording system 320 and the subtraction output data from the subtraction circuit 351, that is, read RF data from which the recording signal crosstalk from the first recording system 310, recording signal crosstalk from the second recording system 320 and power transmission signal crosstalk from the power transmission system 330 have been canceled, and supplying the second pseudo recording signal crosstalk signal thus generated to the subtraction circuit 351.

The third adaptive filter 352C automatically adjusts the transfer function, to minimize the power transmission signal crosstalk component included in the subtraction output data from the subtraction circuit 351, by generating the pseudo power transmission signal crosstalk signal from the power transmission signal supplied from the power transmission system 330 and the subtraction output data from the subtraction circuit 351, that is, read RF data from which the recording signal crosstalk from the first recording system 310, recording signal crosstalk from the second recording system 320 and power transmission signal crosstalk from the power transmission system 330 have been canceled, and by supplying the pseudo power transmission crosstalk signal thus generated to the subtraction circuit 351.

The subtraction output data from the subtraction circuit 351, that is, the read RF data having canceled therefrom the recording signal crosstalk from the first recording system 310, recording signal crosstalk from the second recording system 320 and power transmission signal crosstalk from the power transmission system 330 is supplied to a playback signal discrimination circuit 349 via a PLL circuit 347.

The PLL circuit 347 extracts a channel clock (reading clock) from the read RF data having the power transmission signal crosstalk canceled therefrom.

The playback signal discrimination circuit 348 binarizes and outputs the read RF data.

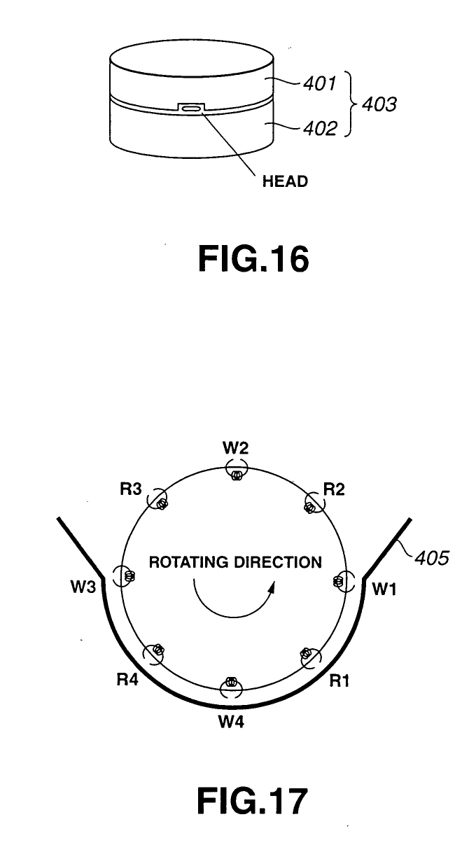

Next, another embodiment of the tape streamer according to the present invention will be described with reference to FIGS. 16 to 19. The tape streamer, generally indicated with a reference umber 400, includes a 4-channel recording system 410.

The tape streamer 400 is a helical-scan type magnetic recording/playback apparatus in which data is written and/or read from a magnetic tape 405 wound over a half (180 deg.) of the circumferential surface of a rotating drum assembly 403 consisting of a rotating drum 401 and stationary drum 402 as shown in FIG. 16. As shown in FIG. 17, the rotating drum 401 has disposed thereon two pairs of write heads W1 to W4 and two pairs of read heads R1 to R4. In two pairs of the write heads, the first write head W1 is diametrically opposite to the third write head W3 while the second write head W2 is so opposite to the fourth write head W4. Also, in two pairs of the read heads, the first read head R1 is diametrically opposite to the third read head R3 while the second read head R2 is so opposite to the fourth read head R4.

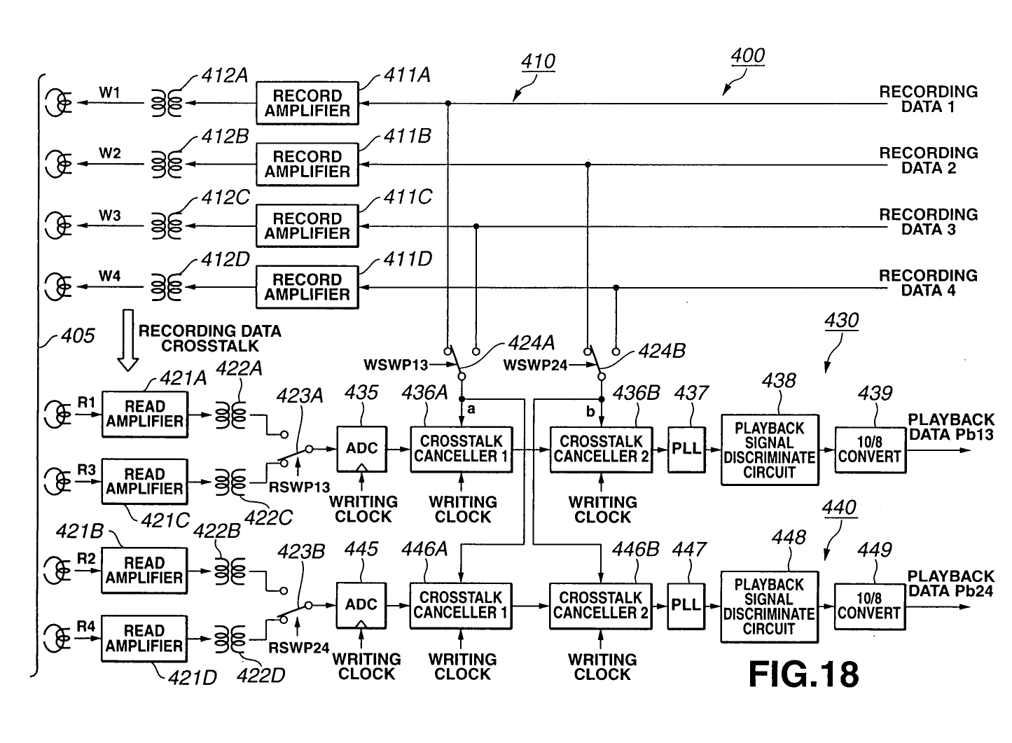

As shown in FIG. 18, in the recording system 410 of the tape streamer 400, recording data WR1 to WR4 on the first to fourth channels, respectively, are amplified by first to fourth write amplifiers 411A to 411D, respectively, provided on the stationary drum 402, and supplied to the first to fourth write heads W1 to W4 provided on the rotating drum 401 via rotary transformers 412A to 412D, respectively.

The first write head W1 is supplied with the recording data WR1 as a recording signal for a period of 180 deg. for which the first write head W1 is sliding on the magnetic tape 405. This period is equivalent to an interval where a head select signal WSWP13 is low. The third write head W3 is supplied with the recording data WR3 as a recording signal for a period of 180 deg. for which the third write head W3 is sliding on he magnetic tape 405. This period is equivalent to an interval where the head select signal WSWP13 is high. That is, the head select signal WSWP13 provides a selection between the first and third write heads W1 and W3 which are diametrically (180 deg.) opposite to each other.

The second write head W2 is supplied with the recording data WR2 as a recording signal for a period of 180 deg. for which the second write head W2 is sliding on the magnetic tape 405. This period is equivalent to an interval where a head select signal WSWP24 is low. The fourth write head W4 is supplied with the recording data WR4 as a recording signal for a period of 180 deg. for which the fourth write head W4 is sliding on the magnetic tape 405. This period is equivalent to an interval where the head select signal WSWP24 is high. That is, the head select signal WSWP24 provides a selection between the second and fourth write heads W2 and W4 which are diametrically (180 deg.) opposite to each other.

The tape streamer 400 includes also a playback system 420. This playback system 420 includes two playback operation systems 430 and 440, first and second. The first playback operation system 430 includes the first and third read heads R1 and R3, reading amplifiers 421A and 421C, rotary transformers 422A and 422C and a first head select switch 423A provided on the stationary drum 402. The second playback operation system 440 includes the second and fourth read heads R2 and R4, reading amplifiers 421B and 421D, rotary transformers 422B and 422D and a second head select switch 423B also provided on the stationary drum 402. In these first and second playback operation system 430 and 440, recording tracks on the magnetic tape 405 having the recording data recorded thereon by the first to fourth write heads W1 to W4 included in the recording system 410 and provided on the rotating drum 401 are scanned by the first to fourth read heads R1 to R4 to provide a reproduce RF signal on each channel, the reproduce RF signals are amplified by the reading amplifiers 421A to 421D, respectively, and supplied to the first and second head select switches 423A and 423B.

The first playback operation system 430 includes an analog-to-digital converter (ADC) 435, first and second crosstalk cancellers 436A and 436B, PLL circuit 437, playback signal discrimination circuit 438 and a 10/8 conversion circuit 439, all connected in series to the first head select switch 423A.

The second playback operation system 440 includes an analog-to-digital converter (ADC) 445, third and fourth crosstalk cancellers 446A and 446B, PLL circuit 447, playback signal discrimination circuit 448 and a 10/8 conversion circuit 449, all connected in series to the second head select switch 423B.

The first and second head select switches 423A and 423B are provided to select playback signals from the pair of read heads diametrically (180 deg.) opposite to each other and supply the playback signals to the first and second ADCs 435 and 445. They are put into operation correspondingly to RF switching pulses RSWP13 and RSWP24, respectively.

In the first playback operation system 430, the first head select switch 423A provides a selection corresponding to the RF switching pulse RSWP13 to make a selection between playback signals from the first and third write heads R1 and R3 and supply the selected playback signal to the ADC 435. The read RF data digitized by the ADC 435 is supplied to the PLL circuit 437 via the first and second crosstalk cancellers 436A and 436B. The PLL circuit 437 extracts a channel clock (reading clock) from the read RF data having the recording signal crosstalk canceled therefrom by the first and second crosstalk cancellers 436A and 436B. The playback signal discrimination circuit 438 binarizes the read RF data and provides it as playback data PB13 via the 10/8 conversion circuit 439. In an interval where RSWP13 is low, the playback signal discrimination circuit 438 outputs a playback signal read by the first read head R1. In an interval where RSWP13 is high, the playback signal discrimination circuit 438 outputs a playback signal read by the third read head R3.

Note here that during recording by the first write head W1, the recording data WR1 to be written by the write head W1 will interfere with the playback signal. Since the third write head W3 is in resting phase while the first write head W1 is in operation, the recording data WR3 to be written by the write head W3 will not interfere with the playback signal. The recording data to be written by the second to fourth write heads W2, W3 and W4 will similarly interfere with the playback signal but in different times, respectively.

In the recording system 410 of the tape streamer 400, the first and third write heads W1 and W3 will not operate simultaneously. So, in the first playback operation system 430, the crosstalk between the recording data WR1 and WR3 is canceled by supplying the recording data WR1 and WR3 for supply to the first and third write heads W1 and W3 to the first crosstalk canceller 436A dedicated to the first and third write heads W1 and W3 via a W1/W3 select switch 424A. Similarly, since the second and fourth write heads W2 and W4 will not operate simultaneously, the crosstalk between the recording data WR2 and WR4 is canceled by supplying the second and fourth recording data WR2 and WR4 for supply to the second and fourth write heads W2 and W4 to the second crosstalk canceller 436B dedicated to the second and fourth write heads W2 and W4 via a W2/W4 select switch 424B.

In the second playback operation system 440, the second head select switch 423B operates in response to the RF switching pulse RSWP24 to select a playback signal from the second or fourth read head R2 or R4 and supply it to the ADC 445. The read RF data digitized by the ADC 445 is supplied to the PLL circuit 447 via the first and second crosstalk cancellers 446A and 446B. The PLL circuit 447 extracts a channel clock (reading clock) from the read RF data from which the crosstalk has been canceled by the first and second crosstalk cancellers 446A and 446B. The playback signal discrimination circuit 448 binarizes the read RF data and provides it as playback data via the 10/8 conversion circuit 449. In an interval where RSWP24 is low, the playback signal discrimination circuit 448 outputs a playback signal read by the second read head R2. In an interval where RSWP24 is high, the playback signal discrimination circuit 448 outputs a playback signal read by the fourth read head R4.

In the recording system 410 of the tape streamer 400, the second and fourth write heads W2 and W4 will not operate simultaneously. So, in the second playback operation system 440, the crosstalk between the recording data WR2 and WR4 is canceled by supplying the recording data WR2 and WR4 for supply to the second and fourth write heads W2 and W4 to the third crosstalk canceller 446A dedicated to the second and fourth write heads W2 and W4 via the W2/W4 select switch 424B. Similarly, since the first and third write heads W1 and W3 will not operate simultaneously, the crosstalk between the recording data WR1 and WR3 is canceled by supplying the first and third recording data WR1 and WR3 for supply to the first and third write heads W1 and W3 to the fourth crosstalk canceller 446B dedicated to the first and third write heads W1 and W3 via the W1/W3 select switch 424B.

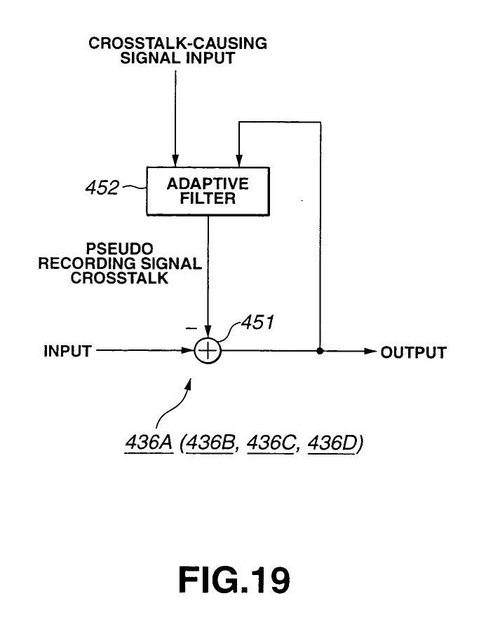

Each of the first to fourth crosstalk cancellers 436A, 436B, 446A and 446B is composed of an adaptive filter 451 and subtraction circuit 452 as shown in FIG. 19.

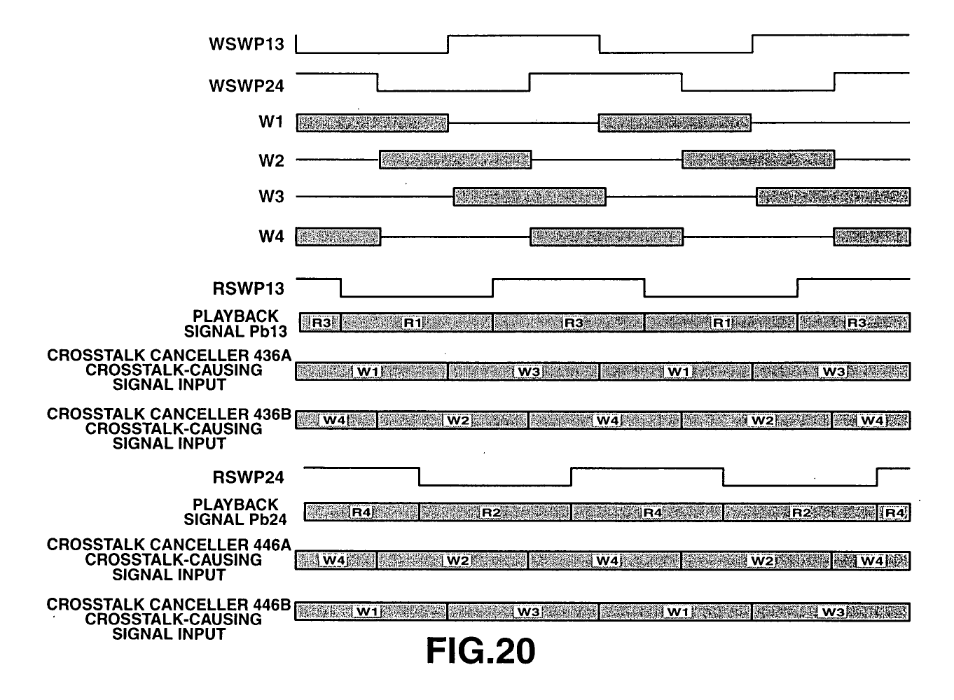

As shown in FIG. 20, in the first playback operation system 430 of the tape streamer 400, playback data PB13 can be provided by canceling the crosstalk between the recording data WR1 and WR3 by supplying, via the W1/W3 select switch 424A to the first crosstalk canceller 436A dedicated for the first and third write heads W1 and W3, the recording data WR1 and WR3 as signals causing the crosstalk component included in the playback signal read by either the first or third read head R1 or R3 selected by the first head select switch 423A which operates in response to the RF switching pulse RSWP13 or by canceling the crosstalk between the recording data WR2 and WR4 by supplying the recording data WR2 and WR4 to the second crosstalk canceller 436B dedicated to the second and fourth write heads W2 and W4 via the W2/W4 select switch 424B.

In the second playback operation system 440, playback data PB24 can be provided by canceling the crosstalk between the recording data WR2 and WR4 by supplying, via the W2/W4 select switch 424B to the third crosstalk canceller 446A dedicated for the second and fourth write heads W2 and W4, the recording data WR2 and WR4 as signals causing the crosstalk component included in the playback signal read by either the second or fourth read head R2 or R4 selected by the second head select switch 423B which operates in response to the RF switching pulse RSWP24 or by canceling the crosstalk between the recording data WR1 and WR3 by supplying the recording data WR1 and WR3 to the fourth crosstalk canceller 446B dedicated to the first and third write heads W1 and W3 via the W1/W3 select switch 424A.

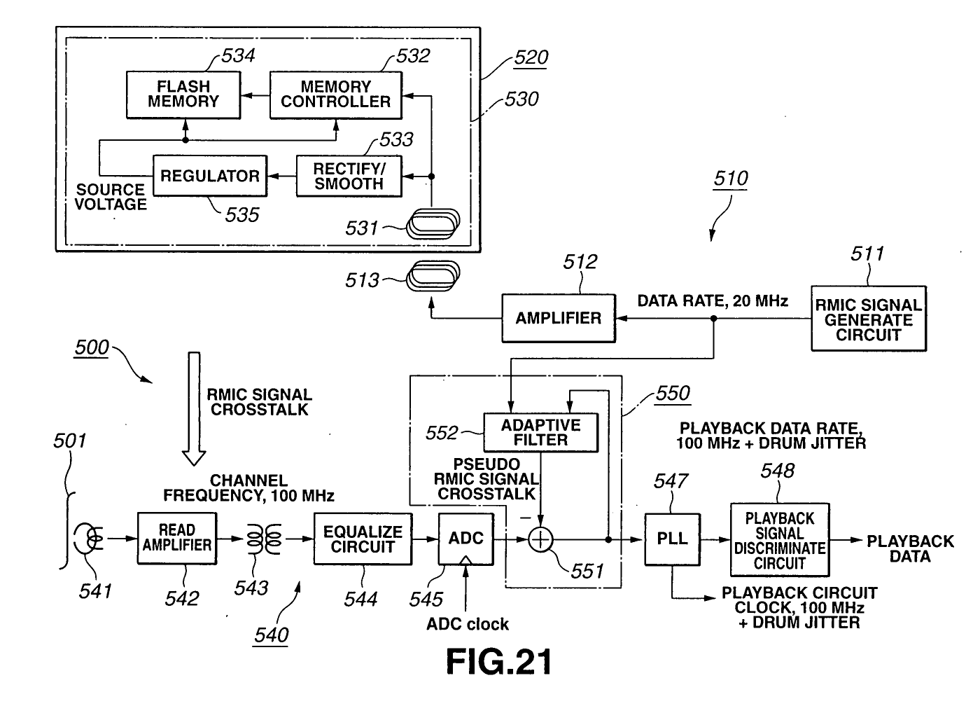

Next, another embodiment of the tape streamer according to the present invention will be described with reference to FIG. 21. In the tape streamer, generally indicated with a reference umber 500, an RMIC (remote memory in cassette) signal crosstalk is canceled in the playback system according to the present invention.

The tape streamer 500 uses a tape cassette 520 having installed therein a remote memory chip 530 including a non-volatile memory which stores various management information on operations of data write and read to and from a magnetic tape 501, and an antenna, radio communications circuit, etc. The tape streamer 500 also includes an RMIC recording/playback system 510 which writes and reads data to and from the non-volatile memory without contact with the tape cassette 520.

The RMIC recording/playback system 510 further includes an RF modulation/amplification circuit 512 which amplifies an RMIC signal generated by an RMIC signal generation circuit 511 and whose rate is 20 MHz and supplies the data to an antenna 513. The RF modulation/amplification circuit 512 makes wireless transmission of the RMIC signal generated by the RIMIC signal generation circuit 511 from the antenna 513 to the remote memory chip 530 installed in the tape cassette 520. It should be noted that the construction and operations of the playback system in the RMIC signal recording/playback system 510 will not be described in detail since it has no direct relation with the present invention.

The remote memory chip 530 installed in the tape cassette 520 includes an antenna 531 provided opposite to the antenna 513 provided in the RMIC signal recording/playback system 510, a memory controller 532 connected to the antenna 531, a rectification/smoothing circuit 533 connected to the memory controller 532, a flash memory 534 connected to the antenna 531, a regulator 535 connected to the rectification/smoothing circuit 533 which rectifies and smoothes an RMIC signal received via the antenna 531, etc. The regulator 535 is provided to stabilize the rectified and smoothed data output from the rectification/smoothing circuit 533 and supply the data output as a source voltage to the memory controller 532 and flash memory 534. The memory controller 532 demodulates an RMIC signal or command and data received via the antenna 531, accesses the flash memory 534 in response to a command, and writes or reads data to or from the flash memory 534.

The flash memory 534 stores data on the manufacture and use of the tape cassette 520, information on partitions on the magnetic tape, etc. as management information. By storing the management information in the non-volatile memory, various operations can be done more efficiently than by recording the management information to a specific area on the magnetic tape. More specifically, it is made unnecessary to run the magnetic tape for write or read of the management information, which contributes to a considerable reduction of the time taken for reading or updating the magnetic information. In other words, it is possible to write or read the management information independently of the position of the write or read head on the magnetic tape or the operation being done. Thus, the management information is applicable in a wider range and can provide a wider variety of effective control operations.

In a playback system 540 in the tape streamer 500, reproduce RF signal obtained through scanning of the recording track on the magnetic tape 501 by a read head 541 is amplified by a read amplifier 542 and supplied to an equalization circuit 544 via a rotary transformer 543.

The equalization circuit 544 adjusts the gain and phase frequency response for the magnetic recording channel transfer characteristic to be as desired. The reproduce RF signal equalized in waveform by the equalization circuit 544 is digitized by an analog-to-digital converter (ADC) 545.

The playback system 540 includes a crosstalk canceller 550 which is supplied with the read RF data digitized by the ADC 545. The crosstalk canceller 550 includes a subtraction circuit 551 which is supplied with the read RF data and an adaptive filter 552 which generates a crosstalk signal of a pseudo RMIC signal from an RMIC signal supplied from the RMIC signal recording/playback system 510 and a subtraction output from the subtraction circuit 551. The pseudo RMIC signal crosstalk signal generated by the adaptive filter 552 will be supplied to the subtraction circuit 551.

The subtraction circuit 551 cancels the RMIC signal crosstalk signal by subtracting the pseudo RMIC signal crosstalk signal generated by the adaptive filter 552 from the read RF data digitized by the ADC 545.

The adaptive filter 552 automatically adjusts the transfer function, to minimize the RMIC signal crosstalk component included in the subtraction output data from the subtraction circuit 551, by generating a pseudo RMIC signal crosstalk signal from the RMIC signal supplied from the RMIC signal recording/playback system 510 and subtraction output data from the subtraction circuit 551, namely, read RF data having the RMIC signal crosstalk canceled therefrom, and supplying the generated pseudo RMIC signal crosstalk signal to the subtraction circuit 551.

The subtraction output data from the subtraction circuit 551, that is, read RF data from which the RMIC signal crosstalk has been canceled, is supplied to a playback signal discrimination circuit 548 via a PLL circuit 547.

The PLL circuit 547 extracts a channel clock (reading clock) from the read RF data having the RMIC signal crosstalk canceled therefrom.

The playback signal discrimination circuit 548 binarizes and outputs the read RF data.

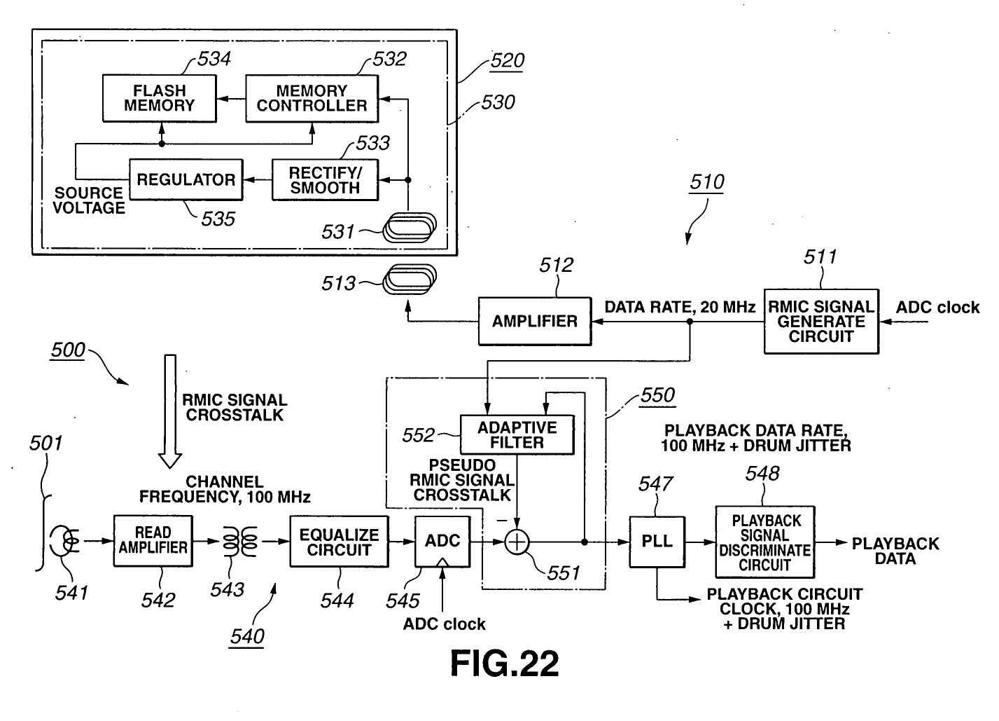

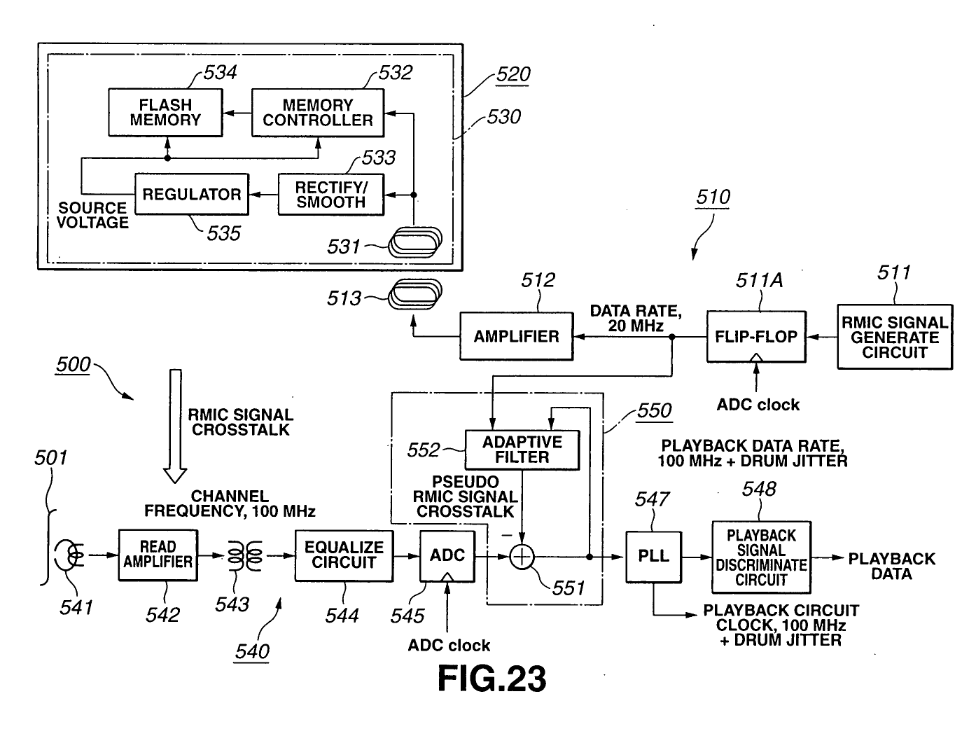

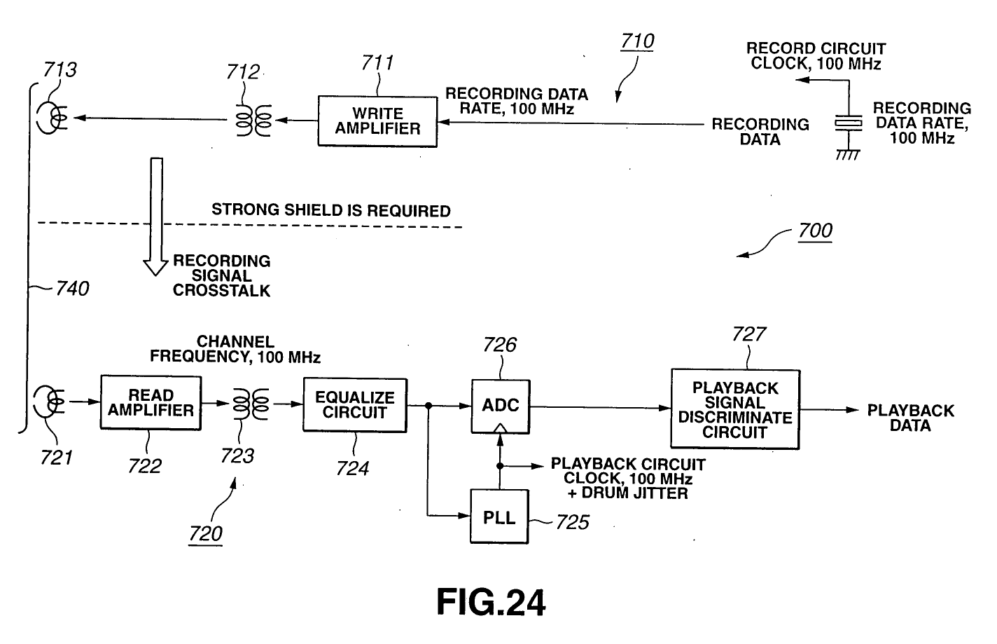

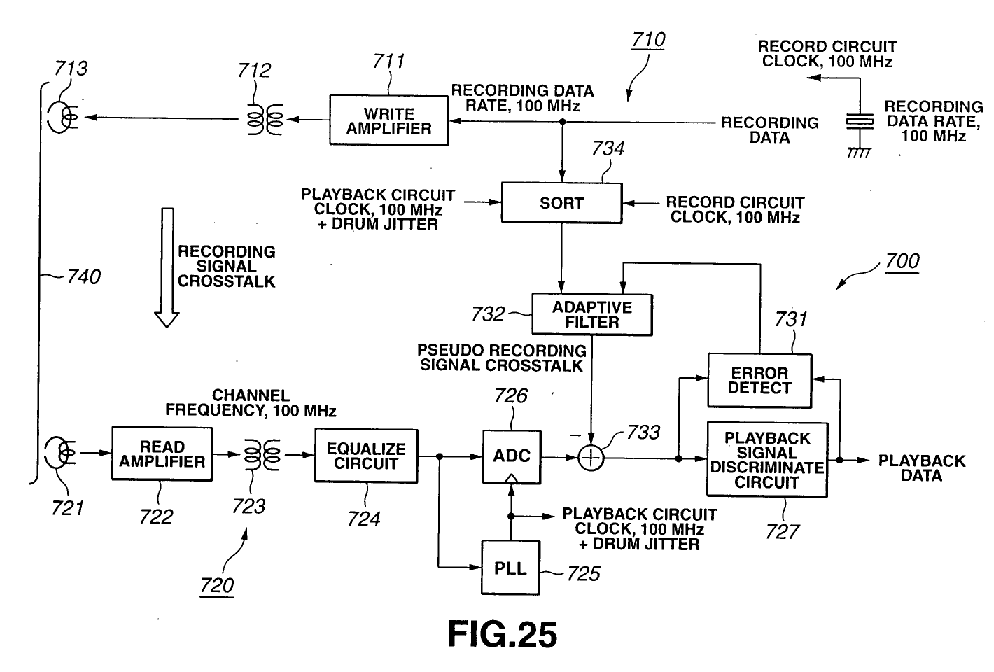

Note here that since the crosstalk cannot be canceled correctly unless the RMIC signal is not synchronous with the ADC clock, the reference clock of the RMIC signal generation circuit 511 is made equal to the ADC clock, as shown in FIG. 22. With this operation, the RMIC signal can be made synchronous with the ADC clock.

In case the RMIC signal generation circuit 511 operates independently of the ADC clock, a flip-flop 511A which operates with an ADC clock should be provided at the output of the RMIC signal generation circuit 511, so that output data (RMIC signal) from the RMIC signal generation circuit 511 is re-sampled with the ADC clock to provide an RMIC signal synchronous with the ADC clock.

### Industrial Applicabilty

As having been described in the foregoing, the present invention assures a higher apparatus reliability by reducing the error rate of the RAW operation and improving the accuracy of detecting a head contamination and tape defect, for which the RAW operation is intended.

The recording/playback apparatus according to the present invention will not incur any malfunction of the PLL circuit and playback signal discrimination circuit because the crosstalk is canceled upstream of the PLL circuit. That is, the recording/playback apparatus can operate even with a low S/N ratio. Since all the circuits of the recording/playback apparatus work with the ADC clock, no recording signal sorting means will be required, which will lead to a simpler system construction.

According to the present invention, a high-precision crosstalk cancel by a multi-tap transversal filter can be achieved.

Also, according to the present invention, the electromagnetic shielding may be constructed simply, which will contribute to a smaller equipment design and lower manufacturing cost.

1-9. (Cancelled)

10. A recording/playback apparatus provided with a playback system which reproduces data by digitizing a playback signal from a recording medium and extracting a channel clock from the digitized playback signal, the apparatus comprising:
a subtracting means supplied with the digitized playback signal and an adaptive filter which generates a pseudo crosstalk signal from output data from the subtracting means and a signal causing a crosstalk signal included in the playback signal, both provided upstream of the channel clock extracting means,
the subtracting means and adaptive filter forming together a means for canceling the crosstalk included in the digitized playback signal by supplying the pseudo recording crosstalk signal to the subtracting means and canceling it from the digitized playback signal.

11. The apparatus as set forth in claim 10, wherein the adaptive filter has a function of optimizing the characteristic of the adaptive filter and storing the filter factor included in the optimized adaptive filter characteristic into a non-volatile storage means.

12. The apparatus as set forth in claim 10, wherein:
recording data from a recording system which records data to the recording medium is supplied as a signal causing a crosstalk signal included in the playback signal to the adaptive filter; and
the adaptive filter has a function of optimizing the adaptive filter characteristic by supplying the recording data to the adaptive filter without the digitized playback signal being provided as an output.

13. The apparatus as set forth in claim 10, wherein:
recording data from a recording system which records data to the recording medium is supplied as a signal causing a crosstalk signal included in the playback signal to the adaptive filter; and
the playback signal from the recording medium is digitized by an analog-to-digital conversion means driven with a recording clock of the recording system and a recording signal crosstalk included in the digitized playback signal is canceled by the crosstalk canceling means, in the playback system.

14. The apparatus as set forth in claim 10, wherein:
a power transmission signal from a power transmission system is supplied as a signal causing a crosstalk included in the playback signal to the adaptive filter; and
a power transmission signal crosstalk is cancelled by the crosstalk canceling means in the playback system.

15. The apparatus as set forth in claim 14, wherein a power transmission signal synchronous with a driving clock of the analog-to-digital conversion means which digitizes the playback signal from the recording medium is supplied from the power transmission system to the adaptive filter.

16. The apparatus as set forth in claim 15, further comprising a sampling means for sampling, with the driving clock, a power transmission signal asynchronous with the driving clock of the analog-to-digital conversion means which digitizes the playback signal from the recording medium,
a power transmission signal sampled by the sampling means being supplied from the power transmission system to the adaptive filter.

17. The apparatus as set forth in claim 10, wherein the crosstalk canceling means includes a first adaptive filter supplied with recording data from the recording system which records data to the recording medium as a signal causing a crosstalk signal included in a playback signal from the recording medium, and a second adaptive filter supplied with a power transmission signal from the power transmission system,
the recording signal crosstalk and power transmission signal crosstalk being canceled by the crosstalk canceling the playback system.

18. The apparatus as set forth in claim 10, further comprising an RMIC (remote memory in cassette) signal recording/playback system which uses a tape cassette having installed therein a non-volatile having stored therein a variety of management information concerning write to, and read from, a magnetic tape as a recording medium and a remote memory chip including an antenna, radio communication circuit, etc. and writes or reads data to or from the non-volatile memory without any contact with the tape cassette,
an RMIC signal from the RMIC signal recording/playback system being supplied as a signal causing a crosstalk signal included in the playback signal; and
an RMIC signal crosstalk being canceled by the crosstalk canceling means in the playback system.
